(19) United States
(12) Patent Application Publication
(10) Pub. No.: US 2016/0223956 A1
(43) Pub. Date: Aug. 4, 2016

(54) IMAGE FORMING APPARATUS

(71) Applicant: CANON KABUSHIKI KAISHA, Tokyo (JP)

(72) Inventor: Tohru Nakaegawa, Nagareyama-shi (JP)

(21) Appl. No.: 15/005,070

(22) Filed: Jan. 25, 2016

(30) Foreign Application Priority Data
Feb. 4, 2015 (JP) 2015-020757

(51) Int. Cl. G03G 15/16

(52) U.S. Cl. CPC G03G 15/1665; G03G 15/1605

(57) ABSTRACT

An image forming apparatus includes an image bearing member, an intermediary transfer member, a plurality of stretching members, a transfer member, a constant-voltage element, a voltage source, an obtaining portion for obtaining information on an image ratio of a toner image formed on the image bearing member, a voltage controller for controlling the voltage source so that a first voltage is applied to the transfer member in a period in which primary transfer of the toner image is executed and secondary transfer of the toner image is not executed and so that a second voltage larger than the first voltage is applied to the transfer member in a period in which the secondary transfer of the toner image is executed, and an adjusting portion for adjusting the first voltage on the basis of the information obtained by the obtaining portion.

### FIELD OF THE INVENTION AND RELATED ART

The present invention relates to an image forming apparatus, such as a copying machine or a printer, of an electrophotographic type.

In a conventional image forming apparatus of an electrophotographic type, in order to meet various recording materials, an intermediary transfer type in which a toner image is primary-transferred from a photosensitive member onto an intermediary transfer member and then is secondary-transferred from the intermediary transfer member onto a recording material has been known. In general, in the image forming apparatus of the intermediary transfer type, in order to primary-transfer the toner image from the photosensitive member onto the intermediary transfer member, a primary transfer member contacting the intermediary transfer member toward the photosensitive member is provided, and a voltage is applied from a voltage source exclusively for the primary transfer to the primary transfer member, so that a primary transfer electric field is formed at a primary transfer portion. Further, in order to secondary-transfer the toner image from the intermediary transfer member onto the recording material, a secondary transfer contacting the intermediary transfer member is provided, and a voltage is applied from a voltage source exclusively for the secondary transfer to the secondary transfer member, so that a secondary transfer electric field is formed at a secondary transfer portion. In this constitution, separated from the voltage source exclusively for the secondary transfer, the voltage source exclusively for the primary transfer is needed.

On the other hand, Japanese Laid-Open Patent Application 2012-98709 has proposed discloses a constitution in which both of primary transfer and secondary transfer are effected by causing a current to flow from a secondary transfer portion to an intermediary transfer member with respect to a circumferential direction. That is, an electroconductive endless belt (intermediary transfer belt) capable of causing the current to flow through the belt with respect to the circumferential direction is used as the intermediary transfer member, and stretching rollers for this belt are grounded via a Zener diode as a passive element, and then a current is caused to flow through the belt by applying a voltage to a secondary transfer member. In the case where the stretching rollers are grounded via the Zener diode, by applying a voltage having a certain value or more to the secondary transfer member, a potential of the intermediary transfer belt is maintained at an arbitrary Zener voltage (breakdown voltage). Further, by applying the voltage to the secondary transfer member, a current flows into the photosensitive member via the intermediary transfer belt, so that the primary transfer electric field can be formed at the primary transfer portion similarly as in the case where the voltage source exclusively for the primary transfer is provided.

In the image forming apparatus including the voltage source exclusively for the primary transfer and the voltage source exclusively for the secondary transfer, the voltage can be applied to the primary transfer member independently of the secondary transfer member, and therefore the voltage can be applied to the secondary transfer member only during a secondary transfer step.

However, in a constitution from which the voltage source exclusively for the primary transfer is omitted, a transfer step is executed at the primary transfer portion and the secondary transfer portion using a common voltage source. For that reason, typically, the voltage is applied to the secondary transfer member during a period from start of a primary transfer step to end of a secondary transfer step. Therefore, there is a possibility that a deterioration of the secondary transfer member is accelerated and thus a lifetime of the secondary transfer member is shortened. Particularly, in the case where the image forming apparatus is used in a low-temperature and low-humidity environment, the voltage applied to the secondary transfer member is set at a relatively high value in general, and therefore the shortened lifetime due to the deterioration of the secondary transfer member is more liable to be conspicuous.

### SUMMARY OF THE INVENTION

According to an aspect of the present invention, there is provided an image forming apparatus comprising: an image bearing member for bearing a toner image; an intermediary transfer member for carrying the toner image primary-transferred from the image bearing member at a primary transfer position; a plurality of stretching members for stretching the intermediary transfer member in contact with an inner peripheral surface of the intermediary transfer member; a transfer member, urged from an outer peripheral surface of the intermediary transfer member toward the intermediary transfer member, for secondary-transferring the toner image from the intermediary transfer member onto a recording material at a secondary transfer position; a constant-voltage element, electrically connected between the intermediary transfer member and a ground potential, for maintaining a predetermined voltage by a flow of a current therethrough; a voltage source for applying a voltage to the transfer member so as to form a secondary transfer electric field at the secondary transfer position and a primary transfer electric field at the primary transfer position; an obtaining portion for obtaining information on an image ratio of the toner image formed on the image bearing member; a voltage controller for controlling the voltage source so that a first voltage is applied to the transfer member in a period in which primary transfer of the toner image is executed and secondary transfer of the toner image is not executed and so that a second voltage larger than the first voltage is applied to the transfer member in a period in which the secondary transfer of the toner image is executed; and an adjusting portion for adjusting the first voltage on the basis of the information obtained by the obtaining portion.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus according to Embodiment 1 of the present invention.

FIG. 2 is a schematic view showing a relationship between a potential of an intermediary transfer belt and a potential of an electrostatic image.

FIG. 3 is a graph showing a voltage-current (VI) characteristic of a Zener diode.

FIG. 4 is a block diagram showing a control mode of a principal part of the image forming apparatus in Embodiment 1 of the present invention.

FIG. 5 is a graph showing a relationship between a voltage applied to a secondary transfer roller and a current flowing into the Zener diode.

FIG. 6 is a graph showing a relationship between the voltage applied to the secondary transfer roller and the current flowing into the Zener diode at different image ratios.

FIG. 7 is a flowchart of control in Embodiment 1.

FIG. 8 is a timing chart for illustrating control in Embodiment 2.

FIG. 9 is a timing chart for illustrating control in Embodiment 2.

### DESCRIPTION OF THE EMBODIMENTS

An image forming apparatus according to the present invention will be described with reference to the drawings.

### Embodiment 1

### 1. General Constitution and Operation of Image Forming Apparatus

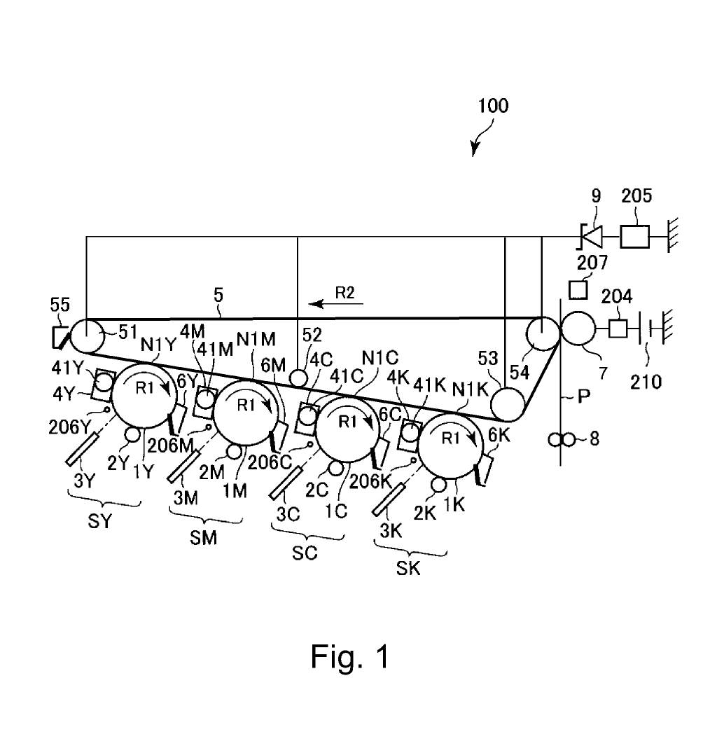

FIG. 1 is a schematic sectional view showing a general structure of an image forming apparatus 100 in this embodiment according to the present invention.

The image forming apparatus 100 in this embodiment employs a tandem type in which image forming means for forming color toner images using an electrophotographic type are independently provided. Further, the image forming apparatus 100 in this embodiment employs an intermediary transfer type in which toner images formed by a plurality image forming means are primary-transferred onto an intermediary transfer member and then are secondary-transferred from the intermediary transfer member onto a recording material.

The image forming apparatus 100 includes, as the plurality of image forming means, first to fourth image forming portions (units or stations) SY, SM, SC and SK for forming toner images of yellow (Y), magenta (M), cyan (C) and black (K), respectively. These (first to fourth) image forming portions SY, SM, SC and SK are disposed in this order from an upstream side with respect to a movement direction of the intermediary transfer member. In this embodiment, constitutions and operations of the image forming portions SY, SM, SC and SK are substantially the same except that the colors of toners used are different from each other. Accordingly, in the following, in the case where particular distinction is not required, suffixes Y, M, C and K for representing elements for associated colors are omitted, and the elements will be collectively described.

At the image forming portion S, a photosensitive drum 1 which is a rotatable drum-shaped (cylindrical) electrophotographic photosensitive member as an image bearing member is provided. At the image forming portion S, at a periphery of the photosensitive drum 1, the following devices are provided. First, a charging roller 2 which is a roller-type charging member as a charging means is disposed. Then, an exposure device 3 as an exposure means is disposed. Then, a developing device 4 as a developing means is disposed. Further, a drum cleaning device 6 as a drum cleaning means is disposed.

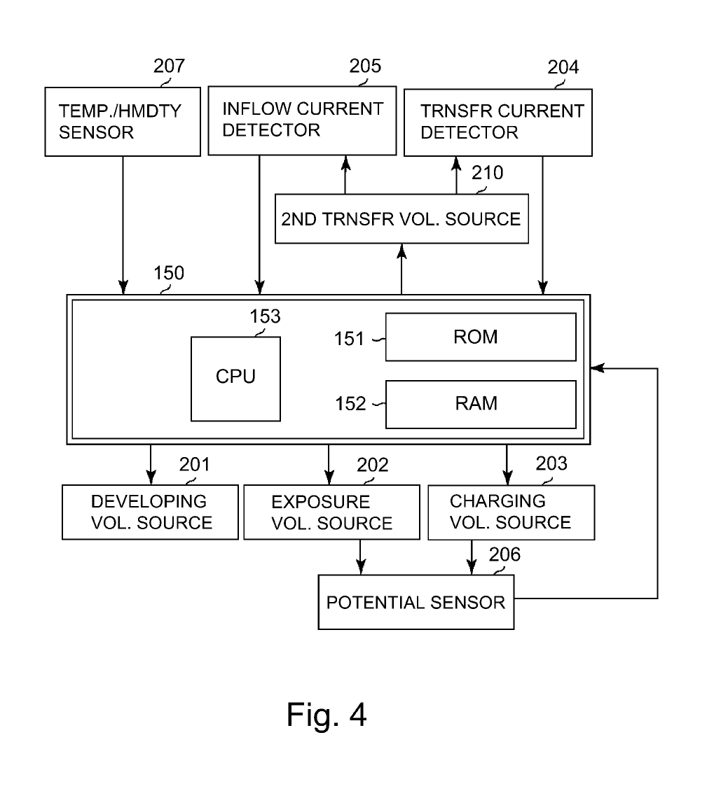

The photosensitive drum 1 is rotationally driven in an indicated arrow R1 direction at a predetermined peripheral speed (process speed). A surface of the rotating photosensitive drum 1 is electrically charged to a predetermined polarity (negative in this embodiment) and a predetermined potential by the charging roller 2. During the charging, to the charging roller 2, a charging voltage (charging bias) is applied from a charging voltage source (charging high-voltage source) 203 (FIG. 4) as a charging voltage applying means. The charged surface of the photosensitive drum 1 is exposed to light by the exposure device 3. The exposure device 3 includes a laser scanner, and an output of this laser scanner is turned on and off based on image information, so that an electrostatic image (electrostatic latent image) corresponding to an image is formed on the photosensitive drum (photosensitive member) 1. During the exposure, to the laser scanner, a driving voltage is applied from an exposure voltage source (exposure high-voltage source) 202 (FIG. 4) as an exposure voltage applying means. In this embodiment, an electrostatic image forming means for forming the electrostatic image on the photosensitive drum 1 is constituted by the charging roller 2 and the exposure device 3.

The electrostatic image formed on the photosensitive drum 1 is developed (visualized) in to a toner image with a toner as a developer by the developing device 4. The developing device 4 includes a developing container for accommodating the toner, and a developing roller 41 as a developer carrying member for carrying and feeding the toner to the photosensitive drum 1. During the development, to the developing roller 41, a developing voltage (developing bias) is applied from a developing voltage source (developing high-voltage source) 201 (FIG. 4) as a developing voltage applying means. In this embodiment, the toner image is formed by image portion exposure and reverse development. That is, the toner charged to the same polarity as the charge polarity of the photosensitive drum 1 is deposited on an exposed portion of the photosensitive drum 1 lowered in absolute value of the potential by the exposure to light after the photosensitive drum 1 is uniformly charged.

A rotatable intermediary transfer belt 5 constituted by an endless belt as the intermediary transfer member is provided opposed to the photosensitive drums 1Y, 1M, 1C, 1K of the image forming portions SY, SM, SC, SK. The intermediary transfer belt 5 is stretched by first and second idler rollers 52, 53 and a driving roller (secondary transfer inner roller) 54 (these rollers are also referred collectively as stretching rollers). The intermediary transfer belt 5 is rotationally driven in an indicated arrow R2 direction at substantially the same peripheral speed as the peripheral speed of the photosensitive drum 1. The intermediary transfer belt 5 forms primary transfer portions (primary transfer nips) N1Y, N1M, N1C, N1K where an outer peripheral surface thereof contacts the respective photosensitive drums 1Y, 1M, 1C, 1K. The toner image formed on the photosensitive drum 1 is transferred (primary-transferred) electrostatically onto the intermediary transfer belt 5 at the primary transfer portion N1. For example, during full-color image formation, the respective color toner images formed on the photosensitive drums 1Y, 1M, 1C and 1K are successively transferred superposedly onto the intermediary transfer belt 5 at the primary transfer portions N1Y, N1M, N1C, N1K. At this time, at the primary transfer portion N1, a primary transfer electric field for moving the toner from the photosensitive drum 1 to the intermediary transfer belt 5 is formed. The primary transfer will be further described later in detail. A toner (primary transfer residual toner) remaining on the photosensitive drum 1 after the primary transfer is removed and collected from the photosensitive drum 1 by the drum cleaning device 6.

On the other hand, at a position opposing the driving roller 54 on an outer peripheral surface side of the intermediary transfer belt 5, secondary transfer roller (secondary transfer outer roller) 7 which is a roller-shaped secondary transfer member as a secondary transfer means is provided. The secondary transfer roller 7 is urged (pressed) against the intermediary transfer belt 5 toward the driving roller 54 and forms a secondary transfer portion (secondary transfer nip) N2 where the intermediary transfer belt 5 and the secondary transfer roller 5 are in contact with each other. A recording material P such as a recording sheet is accommodated in a tray (not shown). The recording material P is taken out from the tray at predetermined timing by a pick-up roller (not shown) and then is fed to a registration roller pair 8 by a feeding roller (not shown). The recording material P is fed to the secondary transfer portion N2 in synchronism with the toner images on the intermediary transfer belt 5 by the registration roller pair 8. With the secondary transfer roller 7, a secondary transfer voltage source (secondary transfer high-voltage source) 210 as a secondary transfer voltage applying means is connected. The toner images on the intermediary transfer belt 5 is transferred (secondary-transferred) electrostatically onto the recording material P nipped and fed at the secondary transfer portion N2 by the intermediary transfer belt 5 and the secondary transfer roller 7. At this time, to the secondary transfer roller 7, a secondary transfer voltage (secondary transfer bias) which is a DC voltage of an opposite polarity to a charge polarity (normal charge polarity) of the toner during the development is applied from a secondary transfer voltage source 210. As a result, a secondary transfer electric field for moving the toner from the intermediary transfer belt 5 to the recording material P is formed. With respect to a rotational direction of the intermediary transfer belt 5, downstream of the secondary transfer portion N2 and upstream of the upstreammost primary transfer portion N1Y, a belt cleaning device 55 as an intermediary transfer belt cleaning means is provided. In this embodiment, the belt cleaning device 55 is disposed at a position opposing a tension roller 51 via the intermediary transfer belt 5. A toner (secondary transfer residual toner) or paper powder remaining on the intermediary transfer belt 5 after the secondary transfer is removed and collected from the intermediary transfer belt 5 by the belt cleaning device 55.

The recording material P on which the toner image is transferred is fed to a fixing device (not shown), in which the toner image is heated and pressed and thus is fixed on the recording material P. Thereafter, the recording material P is discharged to an outside of the image forming apparatus 100.

In this embodiment, the image forming apparatus 100 is capable of executing operations in a one-side printing mode, an automatic double-side printing mode and a manual double-side printing mode which are employed as a sheet feeding mode (image forming mode). In the operation in the one-side printing mode, an image is formed on one surface of the recording material P and then is outputted. In the operation in the automatic double-side printing mode, front and back surfaces of the recording material P are automatically reversed (turned upside down) by a double-side mechanism (not shown), so that the image is formed on both surfaces of the recording material P and then is outputted. In the operation in the manual double-side printing mode, the recording material P on which the image is formed at one surface and which is then outputted is manually turned upside down by an operator such as a user, and thereafter is placed on a manually feeding tray (not shown) and then the image is formed on the other surface of the recording material P and is outputted.

### 2. Intermediary Transfer Belt

In this embodiment, the intermediary transfer belt 5 has a multi-layer structure in which an electric resistance of a surface layer is higher than an electric resistance of another layer. Specifically, the intermediary transfer belt 5 in this embodiment has a two-layer structure consisting of a base layer and the surface layer. As the base layer, a layer in which an antistatic agent such as carbon black is contained in a proper amount in a resin such as polyimide, polyamide, PEN or PEEK, or various rubbers is used. The base layer is formed so that a volume resistivity of the base layer is 10⁶-10⁸ Ω·cm. In this embodiment, as the base layer, a film-like endless belt formed of polyimide in a center thickness of about 45-100 μm was used. On the base layer, as the surface layer, a coat layer of 10¹³-10¹⁶ Ω·cm in volume resistivity is provided. In this embodiment, as the surface layer, an acrylic coat layer of about 1-10 μm in thickness was used. In this way, the electric resistance of the base layer is lower than the electric resistance of the surface layer.

The intermediary transfer belt 5 is stretched by the tension roller 51, the idler rollers 52, 53 and the driving roller 54 as described above. The idler rollers 52, 53 stretch the intermediary transfer belt 5 extending along an arrangement direction of the four photosensitive drums 1Y, 1M, 1C, 1K. The tension roller 51 applies a certain tension to the intermediary transfer belt 5 and also functions as a correction roller for correcting oblique movement (meandering) of the intermediary transfer belt 5. In this embodiment, the tension of the intermediary transfer belt 5 relative to the tension roller 51 is set at about 5-12 kgf. This belt tension is applied, so that the primary transfer portions N1Y, N1M, N1C, N1K which are contact portions (nips) between the intermediary transfer belt 5 and the photosensitive drums 1Y, 1M, 1C, 1K are formed. The driving roller 54 is driven by a motor (not shown), excellent in constant-speed property, as a driving means, and circulates and drives (rotates) the intermediary transfer belt 5.

In this embodiment, the driving roller 54 includes a core metal (core material) and an electroconductive elastic layer (rubber layer) formed using EPDM rubber on the core metal. This driving roller 54 has an outer diameter of 20 mm and a thickness of 0.5 mm, and a hardness of 70° (Asker-C). In this embodiment, the secondary transfer roller 7 includes a core metal (core material) and an electroconductive elastic layer (rubber layer) formed using NBR rubber or EPDM rubber on the core metal. A diameter of this secondary transfer roller 7 is 24 mm.

### 3. Formation of Primary Transfer Electric Field

The image forming apparatus 100 in this embodiment has a constitution from which a voltage source exclusively for primary transfer is omitted in order to realize cost reduction. For that purpose, in this embodiment, the secondary transfer voltage source 210 is used for electrostatically primary-transferring the toner image from the photosensitive drum 1 onto the intermediary transfer belt 5.

When the stretching rollers 51-54 for the intermediary transfer belt 5 are directly connected with the ground potential, under application of a voltage to the secondary transfer roller 7 by the secondary transfer voltage source 210, there is a liability that a current excessively flows toward the stretching rollers 51-54. That is, even when the voltage is applied from the secondary transfer voltage source 210 to the secondary transfer roller 7, there is a liability that the current does not sufficiently flows in the photosensitive drums 1 of the image forming portions S through the intermediary transfer belt 5. As a result, there is a liability that the primary transfer electric field for transferring the toner images from the photosensitive drums 1 onto the intermediary transfer belt 5 does not sufficiently act on between the intermediary transfer belt 5 and the photosensitive drums 1. Therefore, in the constitution from which the voltage source exclusively for the primary transfer is omitted, in order to cause the primary transfer electric field to act, it is desirable that a passive element is connected between the ground potential and all of the stretching rollers 51-54 and thus an excessive flow of the current through stretching rollers 51-54 is suppressed. As a result, the potential of the intermediary transfer belt 5 becomes high, so that the primary transfer electric field acts on between the photosensitive drums 1 and the intermediary transfer belt 5.

When the electric resistance of the intermediary transfer belt 5 itself is excessively increased, a voltage drop of the intermediary transfer belt 5 becomes large. As a result, there is a liability that the current does not readily flow into the photosensitive drums 1 through the intermediary transfer belt 5. For that reason, it is desirable that the intermediary transfer belt 5 includes a low resistance layer. In this embodiment, in order to suppress the voltage drop of the intermediary transfer belt 5, the intermediary transfer belt 5 is formed so that the base layer thereof has a surface resistivity of 10² Ω/square or more and 10⁸ Ω/square or less.

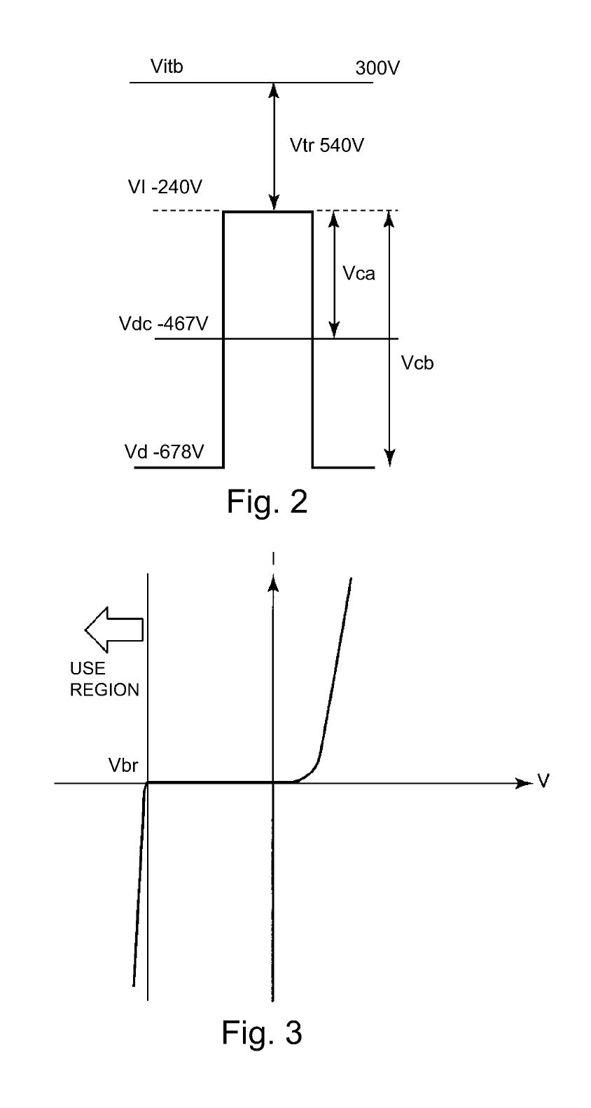

With reference to FIG. 2, a primary transfer contrast which is a difference between the potential of the photosensitive drum 1 and the potential of the intermediary transfer belt 5 will be described. As shown in FIG. 2, the photosensitive drum 1 is charged by the charging roller 2, so that a surface potential thereof is uniformly predetermined charging potential (dark-portion potential) Vd (−678 V in FIG. 2). The charged photosensitive drum 1 is exposed to light by the exposure device 3, so that the third potential thereof is changed to a predetermined exposed portion potential (light-portion potential) Vl (−240 V in FIG. 2). The charging potential Vd is a potential of a non-image portion where the toner is not deposited, and the exposed portion potential Vl is a potential of an image portion where the toner is deposited on the photosensitive drum 1. In FIG. 2, Vitb represents the potential of the intermediary transfer belt 5.

The surface potential of the photosensitive drum 1 is detected by a potential sensor 206 (FIG. 4) as a potential detecting means provided close to the photosensitive drum 1 at a position downstream of an exposure position by the exposure device 3 and upstream of a developing position by the developing device 4 with respect to the rotational direction of the photosensitive drum 1. Then, the surface potential of the photosensitive drum 1 is controlled by a controller 150 described later on the basis of a detection result of the potential sensor 206. That is potential sensor 206 detects the non-image portion potential and the image portion potential on the surface of the photosensitive drum. The controller 150 controls the charging potential of the photosensitive drum 1 by the charging roller 2 on the basis of a detection result of the non-image portion potential, and controls an exposure light amount of the exposure device 3 on the basis of a detection result of the image portion potential. As a result, the surface potential of the photosensitive drum 1 is controlled to a proper value with respect to both of the image portion potential and the non-image portion potential.

Relative to the surface potential of the photosensitive drum 1 controlled as described above, a predetermined developing bias (−467 V as a DC component in FIG. 2) is applied to the developing device 4. As a result, the toner charged to a predetermined polarity (negative in this embodiment) is moved toward the photosensitive drum 1. A developing contrast Vca which is a potential difference between the image portion potential Vl and the developing bias Vdc on the photosensitive drum 1 is −240 V−(−467 V)=227 V. An electrostatic image contrast Vcb which is a potential difference between the image portion potential Vl and the non-image portion potential Vd on the photosensitive drum 1 is −240V−(−678 V)=438 V. A primary transfer contrast Vtr which is a potential difference between the image portion potential Vl on the photosensitive drum 1 and a potential Vitb (300 V in FIG. 2) of the intermediary transfer belt 5 is 300 V−(−240 V)=540 V.

As described above, in this embodiment, when the voltage is applied from the secondary transfer voltage source 310 to the secondary transfer roller 7 during the primary transfer, the current flows into the photosensitive drums 1 via the intermediary transfer belt 5. For that reason, an electric field action similar to the constitution including voltage sources exclusively for the primary transfer at the primary transfer portions N1 acts, so that it is possible to primary-transferring the toner image from each of the photosensitive drums 1 onto the intermediary transfer belt 5. That is, in this embodiment, the current is caused to flow through the intermediary transfer belt 5 in a circumferential direction by the secondary transfer voltage source 210, whereby the intermediary transfer belt 5 is charged and thus a potential is generated at the primary transfer portion N1. Specifically, at the primary transfer portion N1, a predetermined potential of a positive polarity (opposite to the normal charge polarity of the toner) is generated on the intermediary transfer belt 5. The predetermined potential is higher in a positive polarity (opposite to the normal charge polarity of the toner) side relative to the potential of the photosensitive drum 1. As a result, by the action of the primary transfer electric field formed by the potential difference (primary transfer contrast) between the intermediary transfer belt 5 and the photosensitive drum 1 at the primary transfer portion N1, the negatively charged toner on the photosensitive drum 1 is moved onto the intermediary transfer belt 5, so that the primary transfer is effected.

Further, in this embodiment, during the secondary transfer, a potential is generated at the secondary transfer portion N2 by applying a voltage from the secondary transfer voltage source 210 to the secondary transfer roller 7. Specifically, at the secondary transfer portion N2, the predetermined potential of the positive polarity (opposite to the normal charge polarity of the toner) is generated on the secondary transfer roller 7. The predetermined potential is high in a positive polarity (opposite to the normal charge polarity of the toner) side relative to the potential of the intermediary transfer belt 5. As a result, by the action of the secondary transfer electric field formed by the potential difference (secondary transfer contrast) between the intermediary transfer belt 5 and the secondary transfer roller 7 at the secondary transfer portion N2, the negatively charged toner image on the intermediary transfer belt 5 is moved onto the transfer material P, so that the secondary transfer is effected.

### 4. VI Characteristic of Zener Diode

In the constitution from which the voltage source exclusively for the primary transfer, the success or failure of the primary transfer is determined by the primary transfer contrast which is the potential difference between the potential of the intermediary transfer belt 5 and the potential of the photosensitive drum 1. For that reason, in order to stably form the primary transfer contrast, it is desirable that the potential of the intermediary transfer belt 5 is maintained at a constant value. Therefore, in this embodiment, as a passive element connected between the ground potential and the stretching rollers 51-54, a Zener diode which is a constant-voltage element is used.

FIG. 3 shows a voltage-current characteristic (VI characteristic) of the Zener diode. The Zener diode has such a property that the current little flows through the Zener diode until a voltage not less than a Zener voltage (breakdown voltage) Vbr is applied but abruptly flows through the Zener diode when the voltage not less than the Zener voltage is applied. That is, in the case where the voltage applied to the Zener diode is the Zener voltage or more, the voltage drop of the Zener diode is maintained constantly at the Zener voltage. By using such a voltage-current characteristic of the Zener diode, the potential of the intermediary transfer belt 5 can be maintained at a certain level.

In this embodiment, a common Zener diode is connected between the ground potential and all of the stretching rollers 51-54. During the primary transfer, the voltage is applied from the secondary transfer voltage source 210 to the secondary transfer roller 7 so that the voltage applied to the Zener diode is within a range of not less than the Zener voltage. As a result, during the primary transfer, the potential of the intermediary transfer belt 5 can be maintained at the certain level.

In this embodiment, during the secondary transfer, a voltage controlled specifically as described later is applied from the secondary transfer voltage source 210 to the secondary transfer roller 7. This voltage is a voltage which has the same polarity as a voltage (lower limit voltage) necessary to maintain the potential of the intermediary transfer belt 5 at the certain level as described above (i.e., the maintain the voltage applied to the Zener diode at a level not less than the Zener voltage) and which has an absolute value higher than an absolute value of the lower limit voltage. Specifically, in this embodiment, when a job (described later) is started, before the primary transfer at the primary transfer portion N1 is started, application of the lower limit voltage from the secondary transfer voltage source 210 to the secondary transfer roller 7 is started. Thereafter, in a non-overlapping period between the primary transfer and the secondary transfer, this lower limit voltage is continuously applied. Then, before the secondary transfer at the secondary transfer portion N2 is started, application of a voltage necessary for the secondary transfer is started in such a manner that a voltage corresponding to a desired voltage is added to the lower limit voltage. As a result, the potential of the intermediary transfer belt 5 can be maintained at the certain level also during the secondary transfer, and therefore it is possible to effect the primary transfer simultaneously with the secondary transfer. Thereafter, after the secondary transfer at the secondary transfer portion N2 is ended, the voltage application from the secondary transfer voltage source 210 to the secondary transfer roller 7 can be ended. Further, in a paper (sheet) interval (described later) where there is no recording material P at the secondary transfer portion N2 during continuous image formation, the application of the voltage necessary for the secondary transfer may also be contained or returned to the lower limit voltage. Typically, in the job, in a period from start timing of a primary transfer step (specifically from predetermined timing before the start of the primary transfer step) to end timing of the primary transfer step (specifically to predetermined timing after the end of the primary transfer step), a voltage having an absolute value not less than an absolute value of the lower limit voltage is applied to the secondary transfer roller 7.

In this embodiment, the potential Vitb of the intermediary transfer belt 5 is set at 300 V. In this embodiment, 12 Zener diodes 9 each having a Zener voltage Vbr of 25 V are connected in series between the ground potential and the stretching rollers 51-54. In this case, the voltage applied to the Zener diodes 9 is not less than the Zener voltage, the potential Vitb of the intermediary transfer belt 5 is maintained at a constant value which is the sum of the Zener voltages of the 12 Zener diodes 9, i.e., 25×12=300 V. The number of the Zener diodes 9 is not limited to a plural value. It is also possible to use only one Zener diode 9. Further, the surface potential of the intermediary transfer belt 5 is not limited to 300 V. The surface potential of the intermediary transfer belt 5 may appropriately set depending on the species of the toner used and a characteristic of the photosensitive drum 1 used.

### 5. Detection of Current Flowing Through Zener Diode

In this embodiment, the image forming apparatus 100 includes a stretching roller in-flow current detecting circuit (also referred to as an in-flow ammeter) 205 as a current detecting means for detecting a current flowing into the ground potential via the Zener diode 9. In this embodiment, using this in-flow ammeter 205, whether or not the voltage applied to the Zener diode 9 is within a range of not less than the Zener voltage (i.e., whether the voltage applied to the Zener diode 9 is a voltage not less than the Zener voltage or a voltage less than the Zener diode) is discriminated. That is, in the case where the current is not detected by the in-flow ammeter 205 (specifically, in the case where the current not less than a predetermined threshold is not detected), the voltage applied to the Zener diode 9 is discriminated as being less than the Zener voltage. On the other hand, the current is detected by the in-flow ammeter 205 (specifically, in the case where the current not less than the predetermined threshold is detected), the voltage applied to the Zener diode is discriminated as being not less than the Zener voltage.

### 5. Controller

FIG. 4 is a block diagram showing a control mode of a principal part of the image forming apparatus 100 in this embodiment. The image forming apparatus 100 includes the controller (CPU circuit portion) 150 for effecting general control of the image forming apparatus 100. The controller 150 includes a CPU 153 as a processing portion and ROM 151 and RAM 152 as a storing portion. With the controller 150, as a current detecting means for detecting a current flowing through the secondary transfer portion N2, a transfer current detecting circuit (transfer ammeter) 204 is connected. Further, with the controller 150, the above-described in-flow ammeter 205 and potential sensor 206 are connected. In addition, with the controller 150, as an environment detecting means for detecting an ambient condition inside an apparatus main assembly of the image forming apparatus 100, a temperature and humidity sensor 207 for detecting a temperature and a humidity in the image forming apparatus 100 is connected.

Into the controller 150, information on detection results are inputted from the transfer ammeter 204, the in-flow ammeter 205, the potential sensor 206 and the temperature and humidity sensor 207. In the controller 150, the CPU 153 effects centralized control of the secondary transfer voltage source 210, the developing voltage source 201, the exposure voltage source 202 and the charging voltage source 203 depending on a control program stored in the ROM 151. Information on a table for controlling the primary transfer electric field and the secondary transfer electric field depending on the ambient condition and the species (thickness in this embodiment) of the recording material P described later are stored in the ROM 151. The CPU 153 invokes the information on this table and reflects the information in the control. The RAM 152 temporarily holds control data and is used as an operation region for processing with the control.

Here, the image forming apparatus 100 performs a series of image outputting operations (job) which is started by a start instruction (command) and in which an image is formed on a single or a plurality of recording materials P and then the recording materials P are outputted. The job generally includes an image forming step (printing step), a pre-rotation step, a sheet interval step in the case where the image is formed on the plurality of the recording materials P, and a post-rotation step. The image forming step is a period in which formation of the electrostatic latent image for an image formed and outputted on the transfer material P, formation of the toner image, and primary transfer and secondary transfer of the toner image are actually performed, and “during image formation” refers to this period. Specifically, at each of positions where steps of effecting the formation of the electrostatic latent image, the formation of the toner image, and the primary transfer and the secondary transfer of the toner image, timing during image formation is different. The pre-rotation step is a period in which a preparatory operation, from input of the start instruction until the image formation is actually started, before the image forming step is performed. The sheet interval step is a period corresponding to an interval between a recording material P and a subsequent recording material P when the image forming step is continuously performed (continuous image formation) with respect to the plurality of recording materials P. The post-rotation step is a period in which an arranging operation (preparatory operation) after the image forming step is performed. “During non-image formation” refers to a period other than “during image formation”, and includes the pre-rotation step, the sheet interval step, the post-rotation step and further includes a pre-multi-rotation step which is a preparatory operation during main switch actuation of the image forming apparatus 100 or during restoration from a sleep state.

### 7. Control of Secondary Transfer Electric Field

In this embodiment, in order to form a proper secondary transfer electric field, the voltage applied from the secondary transfer voltage source 210 to the secondary transfer roller 7 is controlled by the controller 150. The proper secondary transfer electric field varies depending on the ambient condition and the species (thickness) of the recording material P. For that reason, in this embodiment, an adjusting step which is called ATVC (active transfer voltage control) is executed by the controller 150 during non-image formation (specifically during non-secondary transfer before the secondary transfer step).

The secondary transfer ATVC is roughly the following control. When there is no recording material P at the secondary transfer portion N2, a voltage (adjusting voltage) is applied from the secondary transfer voltage source 210 to the secondary transfer roller 7, and information on a voltage value and a current value at that time are obtained. Then, on the basis of the information, a target value during the secondary transfer voltage to be applied from the secondary transfer is obtained.

The ATVC can be effected in the pre-rotation step in order to determine the target voltage value of the secondary transfer voltage in the job. However, the method of the transfer voltage control is not limited thereto, but the ATVC can be effected in the pre-rotation step every job of plural times. Further, the timing of the secondary transfer ATVC is not limited to the pre-rotation step, but the transfer voltage control can also be effected at appropriate timing if the timing is during the non-image formation such as the pre-multi-rotation step, the sheet-interval step or the post-rotation step.

In this embodiment, the transfer ammeter 204 can detect a value of a DC current flowing through the secondary transfer roller 7 when the secondary transfer voltage source 219 applies the DC voltage to the secondary transfer roller 7. In this embodiment, the secondary transfer voltage source 210 is constituted so that it can output a constant voltage having a voltage value set by control of the controller 150. The controller 150 can obtain pieces of information on the voltage value and the current value from a set value of the output of the secondary transfer voltage source 210 and a detection result of the transfer ammeter 204.

Specifically, in this embodiment, a plurality of adjusting voltages subjected to constant-voltage control are applied from the secondary transfer voltage source 210 to the secondary transfer roller 7 in the ATVC. Then, when the adjusting voltages are applied, currents flowing through the secondary transfer portion N2 are measured by the transfer ammeter 204. As a result, a correlation between the voltage and the current can be calculated. Further, on the basis of the calculated correlation between the voltage and the current, a secondary transfer target voltage V1 for causing a secondary transfer target current It necessary for the secondary transfer to flow through the secondary transfer portion N2 can be calculated. The target current It is set on the basis of Table 1.

TABLE 1

| | WC*¹ (g/cm³) | | | | | | |
|---|---|---|---|---|---|---|---|
| | 0.8 | 2 | 6 | 9 | 15 | 18 | 22 |
| TC*² (μA) | 32 | 31 | 30 | 30 | 29 | 28 | 25 |

*¹“WC” represents a water content.
*²“TC” represents a target current.

Table 1 is a table stored in the ROM 151 provided in the controller 150. In this table, the target current It is set depending on an absolute water content (g/m³) inside the apparatus main assembly of the image forming apparatus 100. When the water content increases the target current It decreases. The absolute water content is calculated by the controller 150 from a temperature and a relative humidity which are detected by the temperature and humidity sensor 207. In this embodiment, the absolute water content is used, but the present invention is not limited thereto. In place of the absolute water content, it is also possible to use the relative humidity.

In this embodiment, a secondary transfer voltage which is a value obtained by adding a recording material sharing voltage V2, with which the recording material P shares, to the above-described target voltage V1 is applied from the secondary transfer voltage source 210 to the secondary transfer roller 7 during the secondary transfer 7. The recording material sharing voltage V2 is set depending in Table 2.

TABLE 2

| PLAIN | | WC*¹ | | | | | | |
|---|---|---|---|---|---|---|---|---|
| PAPER | | 0.8 | 2 | 6 | 9 | 15 | 18 | 22 |
| 64-79 | OS*² | 900 | 900 | 850 | 800 | 750 | 500 | 400 |
| (g/m²) | | | | | | | | |
| (V) | ADS*³ | 1000 | 1000 | 950 | 900 | 850 | 750 | 500 |
| (V) | MDS*⁴ | 1000 | 1000 | 950 | 900 | 850 | 750 | 500 |
| 80-105 | OS*² | 950 | 950 | 900 | 850 | 800 | 550 | 450 |
| (g/m²) | | | | | | | | |
| (V) | ADS*³ | 1050 | 1050 | 1000 | 950 | 900 | 800 | 550 |
| (V) | MDS*⁴ | 1050 | 1050 | 1000 | 950 | 900 | 800 | 550 |
| 106-128 | OS*² | 1000 | 1000 | 950 | 900 | 850 | 600 | 500 |
| (g/m²) | | | | | | | | |
| (V) | ADS*³ | 1100 | 1100 | 1050 | 1000 | 950 | 850 | 600 |
| (V) | MDS*⁴ | 1100 | 1100 | 1050 | 1000 | 950 | 850 | 600 |
| 129-150 | OS*² | 1050 | 1050 | 1000 | 950 | 900 | 650 | 550 |
| (g/m²) | | | | | | | | |
| (V) | ADS*³ | 1150 | 1150 | 1100 | 1050 | 1000 | 900 | 650 |
| (V) | MDS*⁴ | 1150 | 1150 | 1100 | 1050 | 1000 | 900 | 650 |

*¹“WC” represents the water content.
*²“OS” represents the one-side printing.
*³“ADS” represents the automatic double-side printing.
*⁴“MDS” represents the manual double-side printing.

Table 2 is a table stored in the ROM 151 provided in the controller 150. In this table, the recording material sharing voltage V2 is set depending on the absolute water content (g/m³) in an ambience inside the apparatus main assembly of the image forming apparatus 100 and a basis weight (g/m²) of the recording material P. When the basis weight increases, the recording material sharing voltage increases. When the absolute water content increases, the recording material sharing voltage decreases. The recording material sharing voltage V2 is larger during the automatic double-side printing (“ADS”) and the manual double-side printing (“MDS”) than during the one-side printing (“OS”). The basis weight is a unit showing a weight per unit area (g/m²), and is used in general as a value indicating a thickness of the recording material P. The information on the basis weight is inputted by an operator such as a user through an operating portion provided on the image forming apparatus 100 or by an inputting means attached to an accommodating portion for accommodating the recording material P. On the basis of these pieces of information, the controller 150 discriminates the basis weight of the recording material P.

A voltage (V1+V2) obtained by adding the recording material sharing voltage V2 to the target voltage V1 for causing the target current It determined in the adjusting (ATVC) is set as a secondary transfer set voltage Vt subjected to the constant-voltage control in the secondary transfer step subsequent to the adjusting step. As a result, a voltage value for forming a proper secondary transfer electric field is set depending on the ambient condition and the species (thickness) of the recording material P. Further, during the secondary transfer, the secondary transfer voltage is applied in a state of the constant-voltage control, and therefore even when a width of the recording material P changes, the secondary transfer is effected in a stable state.

In this way, in this embodiment, in order to form a proper secondary transfer contrast, the voltage applied from the secondary transfer voltage source 210 to the secondary transfer roller 7 is changed. For example, in the case where the absolute water content is 9 (g/m³), when the recording material P of 64 (g/m²) in basis weight is subjected to the one-side printing and then the recording material P of 150 (g/m²) in basis weight is subjected to the one-side printing, the recording material sharing voltage V2 is changed from 800 V to 950 V (Table 2). Or, in the case where the absolute water content is 9 (g/m³), even when such a condition that the recording material P of 64 (g/m²) in basis weight is subjected to the one-side printing is the same, the target voltage V1 for causing the target current It (30 μmA) determined by the ATVC to flow through the secondary transfer portion N2 changes in some cases (Table 1). This is such a case that an electric resistance of the secondary transfer roller 7 changes depending on the ambient condition, an operation status (change with time) or the like. Or, even when the condition in which the recording material P of 64 (g/m²) in basis weight is subjected to the one-side printing is the same, not only the target current It has also the recording material sharing voltage V2 are changed between the case where the absolute water content is 9 (g/m³) and the case where the absolute water content is 0.8 (g/m³) (Tables 1 and 2).

Here, in the constitution from which the voltage source exclusively for the primary transfer is omitted, the primary transfer contrast is formed using the secondary transfer voltage source 210. For that reason, in order to form the proper secondary transfer voltage, when the voltage applied from the secondary transfer voltage source 210 to the secondary transfer roller 7 is changed, in the case where the primary transfer is effected simultaneously with the secondary transfer, there is a liability that the primary transfer contrast changes. As a result, the proper primary transfer contrast cannot be formed, so that there is a liability that improper primary transfer is caused. However, in this embodiment, even in the case where the primary transfer is effected simultaneously with the secondary transfer, in a range in which a voltage drop of the Zener diode 9 is maintained at a value not less than the Zener voltage, the change in secondary transfer set voltage for forming the proper secondary transfer contrast is made. As a result, even when the voltage applied from the secondary transfer voltage source 210 to the secondary transfer roller 7 in order to form the proper secondary transfer contrast is changed, the change in primary transfer constant is suppressed. For that reason, the proper primary transfer contrast can be formed.

### 8. Control of Primary Transfer Electric Field

In this embodiment, in the case where the primary transfer contrast is adjusted, not the surface potential of the intermediary transfer belt 5, the surface potentials Vd, Vl of the photosensitive drum 1 are changed. The developing bias Vdc is appropriately changed so that a desired developing contrast Vcont and a desired back contrast Vback can be obtained depending on a change in surface potentials Vd, Vl of the photosensitive drum 1. That is, for example, the case where in a state relationship shown in FIG. 2, the image portion potential Vl is changed toward the negative side so as to increase the primary transfer contrast Vtr will be considered. In this case, roughly, control such that the voltages Vd, Vdc, V1 are offset toward the negative side while maintaining the potential relationship shown in FIG. 2 is effected. On the other hand, in the case where the primary transfer contrast is made small, the voltages Vd, Vdc, Vl are offset toward the positive side. At this time, as described above, the surface potential Vitb is maintained at a certain level.

TABLE 3

| | WC*¹ (g/m³) | | | | | | |
|---|---|---|---|---|---|---|---|
| | 22 | 18 | 15 | 9 | 6 | 2 | 0.8 |
| Y | 480 | 525 | 560 | 580 | 605 | 615 | 630 |
| M | 440 | 485 | 520 | 540 | 565 | 575 | 590 |
| C | 440 | 485 | 520 | 540 | 565 | 575 | 590 |
| K | 390 | 435 | 470 | 490 | 515 | 525 | 540 |

*¹“WC” represents the water content.

Table 3 is a table stored in the ROM 151 provided in the controller 150. In this table, the primary transfer contrast is set depending on the forming portions S (colors) and the ambient condition inside the apparatus main assembly of the image forming apparatus 100.

Depending on the surface potential, a current flowing into the photosensitive drum 1 changes. However, in this embodiment, the image portion potential V1 of the photosensitive drum 1 is controlled in the range in which the voltage drop of the Zener diode 9 is maintained at the value not less than the Zener voltage.

For example, the case where when the absolute water content is 9 (g/m³), the recording material P of 64 (g/m²) is subjected to the one-side printing and then the recording material P of 150 (g/m²) is subjected to the one-side printing will be described. In this case, the recording material sharing voltage V2 is changed from 800 V to 950 V, and therefore the secondary transfer set voltage Vt changes (Table 2). On the other hand, the species (thickness) is irrelevant to the primary transfer, and therefore the proper primary transfer contrast is not changed.

In this case, in order to form the proper secondary transfer contrast, the voltage (secondary transfer set voltage Vt) applied from the secondary transfer voltage source 210 to the secondary transfer roller 7 is changed. However, this change is made within the range in which the voltage applied to the Zener diode 9 is the Zener voltage or more even in the case where the primary transfer is effected simultaneously with the secondary transfer. For that reason, the potential of the intermediary transfer belt 5 is maintained constantly at 300 V. In this case, an electrostatic latent image forming condition of the electrostatic latent image forming means is maintained without being not changed. As a result, the primary transfer contrasts at the image forming portions S are maintained at proper values of 580 V, 540 V, 540 V, 490 V.

In this way, an ambient table of the primary transfer contrast for each of the image forming portions S is set in advance, and then control for switching the primary transfer contrast is effected depending on the associated ambience, so that a necessary primary transfer contrast can be obtained every ambience and every color. For example, with respect to a change in necessary primary transfer contrast due to repetitive use of the developer in the developing device 4 or the intermediary transfer belt 5, switching control of the ambient table of the primary transfer contrast can be effected depending on, e.g., an image output sheet number as a value correlating with a use amount. As a result, the necessary primary transfer contrast can be obtained correspondingly to also a change by repetitive use.

### 9. Determining Method of Lower Limit Voltage V0

In this embodiment, as described above, in order to discriminate whether or not the voltage applied to the Zener diode 9 is within the value not less than the Zener voltage, the in-flow ammeter 205 is provided. In this embodiment, the lower limit voltage V0 necessary to maintain the voltage Vitb of the intermediary transfer belt 5 constantly at the Zener voltage is determined in the following manner.

First, the controller 150 causes the surfaces of all of the photosensitive drums 1Y, 1M, 1C, 1K to be electrically charged to a predetermined non-image portion potential Vd. Then, the controller 150 switches the applied voltage, and thus a plurality of different voltages are applied from the secondary transfer voltage source 210 to the secondary transfer roller 7 in a state in which regions of the non-image portion potentials Vd of all of the photosensitive drums 1Y, 1M, 1C, 1K. Then, the current flowing into the Zener diode 9 when each of the voltages is applied is detected by the in-flow ammeter 205.

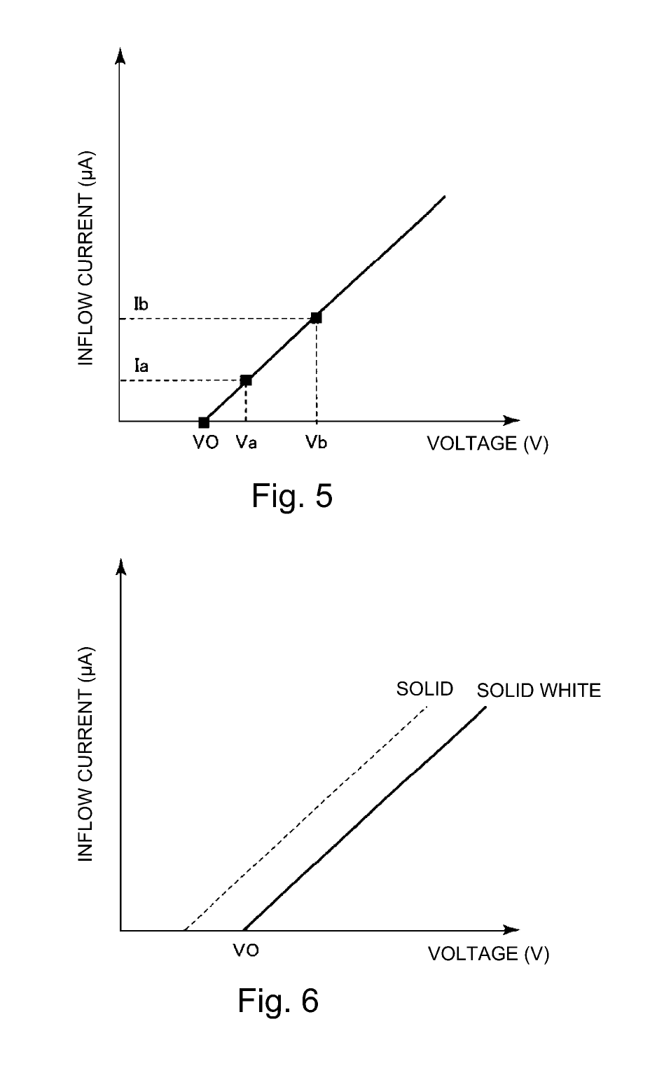

FIG. 5 shows a relationship between the voltage applied from the secondary transfer voltage source 210 to the secondary transfer roller 7 and the current flowing into the Zener diode 9 in a determining operation of the lower limit voltage V0. As shown in FIG. 5, when the voltages Va, Vb are applied, amounts Ia, Ib of currents flowing into the Zener diode 9 are detected. Then, the controller can determine the lower limit voltage V0 necessary to maintain the potential Vitb of the intermediary transfer belt 5 constantly at the Zener voltage by subjecting the VI characteristic to linear interpolation.

This lower limit voltage determining operation can be performed for determining the lower limit voltage V0 in the job in the pre-rotation step every job. The non-image portion potential Vd in the lower limit voltage determining operation may preferably be that set for the image forming step of the job depending on the ambient condition. However, the present invention is not limited thereto, the determining operation of the lower limit voltage V0 may also be performed every job of plural times in the pre-rotation step. Further, the step in which the determining operation is performed is not limited to the pre-rotation step, but the determining operation can be performed at appropriate timing if the timing is during non-image formation such as the pre-multi-rotation step, the sheet interval step or the post-rotation step.

### 10. Correcting Method of Lower Limit Voltage V0

In this embodiment, the lower limit voltage V0 necessary to constantly maintain the potential Vitb of the intermediary transfer belt 5 at the Zener voltage is corrected depending on an image ratio.

FIG. 6 shows a relationship between the voltage applied to the secondary transfer roller 7 and the current flowing into the Zener diode 9 in the case where each of a solid image and a solid white image is formed. The solid image is an image at a maximum density level, and the solid white image is an image (at a portion where the toner is not placed) at a minimum density level. In this embodiment, a solid image potential or a solid white image potential was provided in the entire image forming region (toner image formable region) of all of the photosensitive drums 1Y, 1M, 1C, 1K. Then, in a state in which portions with the respective potentials on the photosensitive drums 1Y, 1M, 1C, 1K contacted the intermediary transfer belt 5, the relationship between the voltage applied from the secondary transfer voltage source 210 to the secondary transfer roller 7 and the current flowing into the Zener diode 9 was checked.

In the case of the solid image, the surface potential of the photosensitive drum 1 changes from the non-image portion potential Vd to the image portion potential Vl, and therefore a potential difference between the surface of the photosensitive drum 1 and the intermediary transfer belt 5 becomes small. For that reason, the current flowing from the intermediary transfer belt 5 into the photosensitive drum 1 relatively becomes small, and the current flowing into the Zener diode 9 relatively becomes large. For that reason, in the case of the solid image, the lower limit voltage V0 necessary to constantly maintain the potential Vitb of the intermediary transfer belt 5 at the Zener voltage is smaller than that in the case of the solid white image. Similarly, in the case of an image having a density between densities of the solid image and the solid white image, the lower limit voltage V0 is between those of the solid member and the solid white image.

In this embodiment, as described above, the lower limit voltage V0 is determined in a state in which the surface of the photosensitive drum 1 is charged to the non-image portion potential Vd, i.e., under a condition of the solid white image potential. In this case, when printing of a specific image is effected at a high frequency in the image forming apparatus 100, particularly when printing of an image with a high predetermined is effected at a high frequency, the lower limit voltage V0 is set at a value higher than an actually needed voltage. As a result, a deterioration of the secondary transfer roller 7 due to energization is accelerated.

Therefore, in this embodiment, the lower limit voltage V0 is corrected depending on the image ratio of the image formed on the photosensitive drum 1. In this embodiment, the image ratio for each of the colors is obtained on the basis of a video count value. Here, the video count value refers to an integrated value of a density level (0-255 levels) per pixel, in each of YMCK image data after conversion of inputted image data, correspondingly to pixels of an image size. Further, with respect to all of the pixels of the image size, a ratio to the video count value in the case where each of images for the colors have the maximum density level. In this embodiment, the video count value is obtained by conversion of RGB image data by the controller 150. In this embodiment, the image ratio is obtained by dividing the image size (e.g., A4 size) into two regions, with respect to a feeding direction and then by being calculated every divided region by the controller 150 as an obtaining means. Then, the controller 150 as an adjusting means discriminates, depending on the calculated image ratio, whether or not correction of the lower limit voltage V0 is needed. In this embodiment, the controller 150 makes the correction so that an absolute value of the lower limit voltage V0 becomes small in the case where the image ratios in all of the divided regions of the formed image exceed 50%, and does not make the correction of the lower limit voltage V0 in the case where the image ratio in either one of the divided regions is 50% or less (Table 4).

TABLE 4

Image ratio

| | 50% or less | 50%-100% |
|---|---|---|
| Correction of V0 | Not executed | Executed |

Here, a correction amount of the lower limit voltage V0 is obtained in advance every ambient condition and is stored as a table in the ROM 151. This correction amount of the lower limit voltage V0 is set within a range in which the voltage applied to the Zener diode 9 during the primary transfer is not less than the Zener voltage and within a range in which the potential Vitb of the intermediary transfer belt 5 can be constantly maintained at the Zener voltage. Further, an absolute value of the lower limit voltage V0 is set at a smaller value within an increasing absolute water content in the ambient condition, and therefore also the correction amount of the lower limit voltage V0 is set so as to be smaller with the increasing absolute water content in the ambient condition.

In this embodiment, the image size was divided into the plurality of regions with respect to the feeding direction to obtain the image ratio in each of the divided regions, and then whether or not the correction of the lower limit voltage V0 should be made was discriminated depending on the image ratio. As a result, also in the case where an image is locally formed with respect to the feeding direction of the recording material with the image size, the potential Vitb of the intermediary transfer belt 5 can be constantly maintained at the Zener voltage during the primary transfer with high reliability. The number of divided regions of the image size is not limited to two, but may also be three or more. Further, during the primary transfer, if the potential Vitb of the intermediary transfer belt 5 can be constantly maintained at the Zener voltage, the image ratio of the entire image size is obtained, and then whether or not the correction of the lower limit voltage V0 should be made may also be discriminated depending on the image ratio. In this embodiment, in the case where the lower limit voltage V0 is corrected, only a predetermined correction amount is corrected, but the correction amount may also be changed continuously depending on the image ratio.

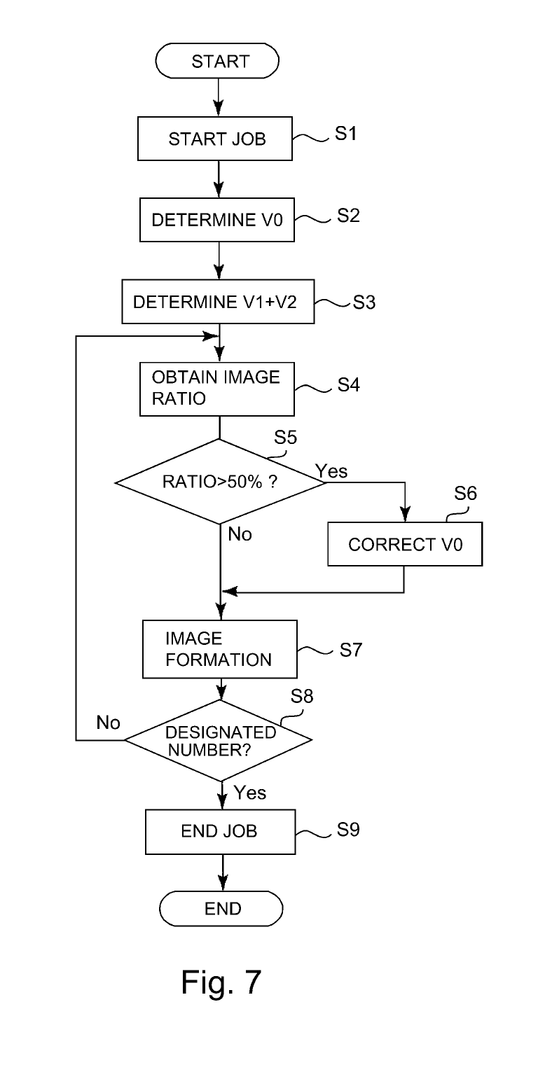

FIG. 7 is a flowchart schematically showing a flow of an operation of a job including a correcting operation of the lower limit voltage V0 in this embodiment. First, when a job is started by an instruction from an operator such as a user (S1), the controller determines the lower limit voltage V0 in the pre-rotation step as described above (S2). Then, the controller 150 determines a secondary transfer set voltage (V1+V2) necessary for the secondary transfer as described above in the pre-rotation step (S3). Then, the controller 150 obtains the image ratio of the image to be formed (S4), and discriminates whether or not the correction of the lower limit voltage V0 is needed as described above (S5). In the step S5, in the case where discrimination that there is no need to make the correction of the lower limit voltage V0 is made, the controller 150 start the image formation at the lower limit voltage V0 set in the step S5 (S7). On the other hand, in the step S5, the discrimination that the correction of the lower limit voltage V0 is needed is made, the controller 150 sets the lower limit voltage V0 so that an absolute value thereof becomes small (S6), and then starts an image forming operation at the set lower limit voltage V0 (S7). Then, the controller 150 repeats the steps S4-S7 until the print number reaches the number of sheets subjected to image output designated in the job (S8), and when the print number reaches the designated number of sheets, the image forming operation is ended (S9).

In this embodiment, the set lower limit voltage V0 (including those which are corrected and which are not corrected) is, in a job for forming a single image, maintained from the time of starting the primary transfer step of the image to at least the time of ending the primary transfer step of the image. Further, in a job for forming a plurality of images, the set lower limit voltage V0 is maintained from start of the primary transfer step of an image to start of the primary transfer step of a subsequent image. With respect to a final image in the job, the set lower limit voltage V0 is maintained from the time of starting the primary transfer step of the final image to at least the time of starting the primary transfer step of the final image. The time of starting the primary transfer step refers to that (specifically, predetermined timing before the start of the primary transfer step) at the upstreammost image forming portion S. The time of ending the primary transfer refers to that (specifically, predetermined timing after the end of the primary transfer step) at the downstreammost image forming portion S. Further, in the job for forming the single image, the set lower limit voltage V0 may also be maintained until the time of ending the secondary transfer step of the single image (specifically, predetermined timing after the end of the secondary transfer step). Similarly, in the job for forming the single image, the set lower limit voltage V0 for the final image may also be maintained until the time of ending the secondary transfer step of the final image (specifically, predetermined timing after the end of the secondary transfer step). When the secondary transfer is effected simultaneously with the primary transfer in the job, as described above, a predetermined voltage is added to the lower limit voltage V0, so that the voltage larger in absolute value than the lower limit voltage V0 is applied.

In this way, in this embodiment, the image forming apparatus 100 includes the intermediary transfer belt 5 which forms the primary transfer portion N1 in contact with the photosensitive member 1 and on which the toner image is primary-transferred from the photosensitive member 1 at the primary transfer portion N1. Further, the image forming apparatus 100 includes the transfer member 7 which forms the secondary transfer portion N2 in contact with the intermediary transfer member 5 and which causes the toner image to be secondary-transferred from the intermediary transfer member 5 onto the recording material P, and includes the voltage source 210 for applying the voltage to the transfer member 7. The image forming apparatus 100 further includes the constant-voltage element 9 connected between the intermediary transfer member 5 and the ground potential. The image forming apparatus forms not only the primary transfer electric field for the primary transfer at the primary transfer portion N1 but also the secondary transfer electric field for the secondary transfer at the secondary transfer portion N2 by applying the voltage from the voltage source 210 to the transfer member 7. The image forming apparatus 100 includes the obtaining means for obtaining the information on the image ratio of the toner image formed on the photosensitive member 1. Further, the image forming apparatus 100 includes the adjusting means for adjusting, on the basis of the information obtained by the obtaining means, the voltage applied from the voltage source 210 to the transfer member 7 when the primary transfer is executed and the secondary transfer is not executed. In this embodiment, the controller 150 has the functions of the obtaining means and the adjusting means. In this embodiment, the adjusting means makes adjustment so that the absolute value of the voltage applied from the voltage source 210 to the transfer member 7 is higher in the case where the image ratio of the information is a first image ratio than in the case where the image ratio is a second image ratio higher than the first image ratio. At this time, the adjusting means makes the adjustment in a range in which a current having a predetermined value or more flows through the constant-voltage element 9 and the potential of the intermediary transfer member 5 is maintained at the certain level.

As described above, according to this embodiment, in the constitution from which the voltage source exclusively for the primary transfer is omitted, the lower limit voltage V0 necessary to constantly maintain the potential Vitb of the intermediary transfer belt 5 at the Zener voltage. As a result, the deterioration due to the energization of the secondary transfer roller 7 is suppressed, so that lifetime extension of the secondary transfer roller 7 can be realized.

### Embodiment 2

Next, another embodiment of the present invention will be described. Basic constitutions and operations of an image forming apparatus in this embodiment are the same as those in Embodiment 1. Accordingly, elements having the same or corresponding functions and constitutions as those in the image forming apparatus in Embodiment 1 are represented by the same reference numerals or symbols and will be omitted from detailed description.

In this embodiment, in the case where the same image is continuously formed, the lower limit voltage NO necessary to constantly maintain the potential Vitb of the intermediary transfer belt 5 at the Zener voltage is corrected depending on a detection result of the in-flow ammeter 205.

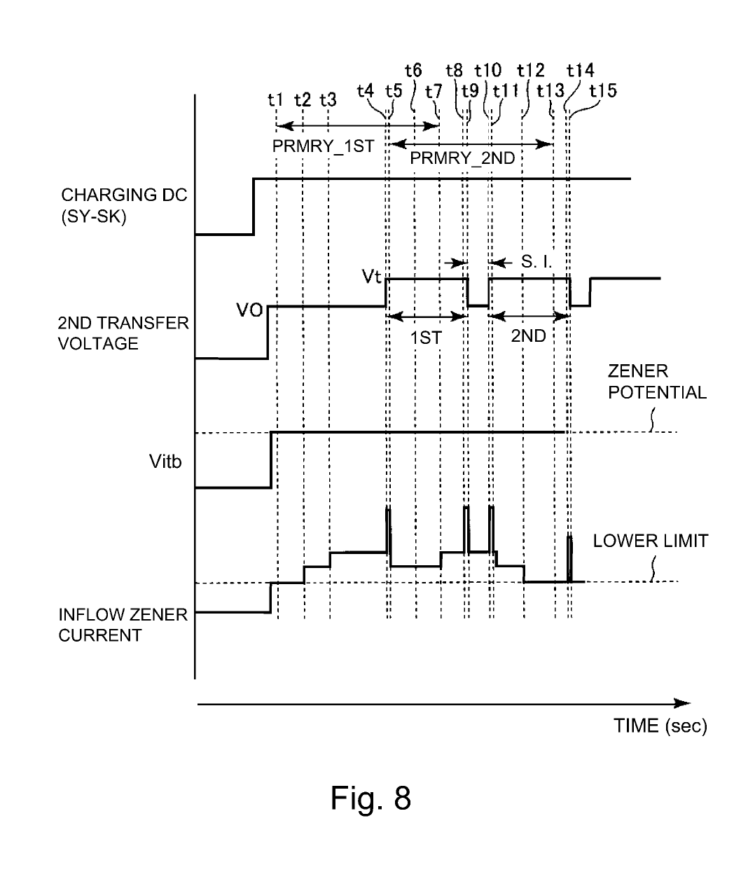

FIG. 8 is a timing chart when a secondary-color solid image of magenta (M) and cyan (C) is continuously formed on A4-sized sheets as an example. In this embodiment, in a pre-rotation step of a job, a lower limit voltage V0 and a secondary transfer set voltage (V1+V2) in the job are determined, and at the set values, image formation is started. In this embodiment, the secondary-color solid image of the magenta (M) and cyan (C) is formed, but the charging of the photosensitive drums 1 to the non-image portion potential Vd is effected at all of the image forming portions S, so that the photosensitive drums 1 contact the intermediary transfer belt 5 at all of the image forming portions S. In FIG. 8, t1-t5 represent the following timings.

t1: timing when a leading end of an image (first sheet) passes through the primary transfer portion N1Y of the first image forming portion SY.

t2: timing when the primary transfer (first sheet) starts at the second image forming portion SM.

t3: timing when the primary transfer (first sheet) starts at the third image forming portion SC.

t4: timing when the primary transfer (first sheet) ends at the second image forming portion SM and the leading end of the recording material (first sheet) passes through the secondary transfer portion N2.

t5: timing when the secondary transfer of the image (first sheet) and the leading end of the image (second sheet) passes through the primary transfer portion N1Y of the first image forming portion SY.

t6: timing when the primary transfer (first sheet) ends at the third image forming portion SC and the primary transfer (second sheet) starts at the second image forming portion SM.

t7: timing when a trailing end of the image (first sheet) passes through the primary transfer portion N1K of the fourth image forming portion SK and the primary transfer (second sheet) starts at the third image forming portion SC.

t8: timing when the secondary transfer of the image (first sheet) ends.

t9: timing when the trailing end of the recording material P (first sheet) passes through the secondary transfer portion N2.

t10: timing when the leading end of the recording material P (second sheet) passes through the secondary transfer portion N2.

t11: timing when the secondary transfer of the image (second sheet) starts.

t12: timing when the primary transfer ends at the third image forming portion SC.

t13: timing when the trailing end of the image (second sheet) passes through the primary transfer portion N1K of the fourth image forming portion SK.

t14: timing when the secondary transfer of the image (second sheet) ends.

t15: timing when the trailing end of the recording material (second sheet) passes through the secondary transfer portion N2.

As shown in FIG. 8, between t2 to t6 and between t6 and t12, the surface potentials of the photosensitive drums 1M, 1C of the second and third image forming portions SM, SC are changed from the non-image portion potential Vd to the image portion potential Vl, and therefore a value of a current flowing into the Zener diode 9 increases. Further, between t4 and t5, between t8 and t9, between t10 and t11 and between t14 and t15 correspond to a marginal portion of the recording material P, and therefore the value of the current flowing into the Zener diode 9 increases.

That is, the current flowing into the Zener diode 9 fluctuates during the primary transfer (from the time of starting the primary transfer at the upstream primary transfer portion N1 to the time of ending the primary transfer at the downstreammost primary transfer portion N1) of the image for the first sheet. Of this fluctuating current, a minimum current said be said to be a current necessary to constantly maintain the potential of the intermediary transfer belt 5 at the Zener voltage for primary-transferring the image. For that reason, in the case where the same image as this image is continuously formed, a current larger than the minimum current is excessively supplied than the necessary current for primary-transferring the image. As a result, the deterioration of the secondary transfer roller 7 due to the energization is accelerated.

Therefore, in this embodiment, in the case where the same image is continuously formed, when the image for the first sheet is primary-transferred, the fluctuation in current flowing into the Zener diode 9 is detected by the in-flow ammeter 205. Then, depending on information thereof, the primary transfer of the images for the second sheet and later is effected, but when the secondary transfer is not effected (during the sheet interval at the secondary transfer portion N2), the voltage (lower limit voltage V0) applied from the secondary transfer voltage source 210 to the secondary transfer roller 7 is corrected. At this time, in this embodiment, the voltage applied from the secondary transfer voltage source 210 to the secondary transfer roller 7 is corrected so that an in-flow current having the smallest absolute value of these of the fluctuating in-flow current detected above can be obtained. As a result, a voltage having an absolute value smaller than the absolute value of the originally set lower limit voltage V0 is applied.

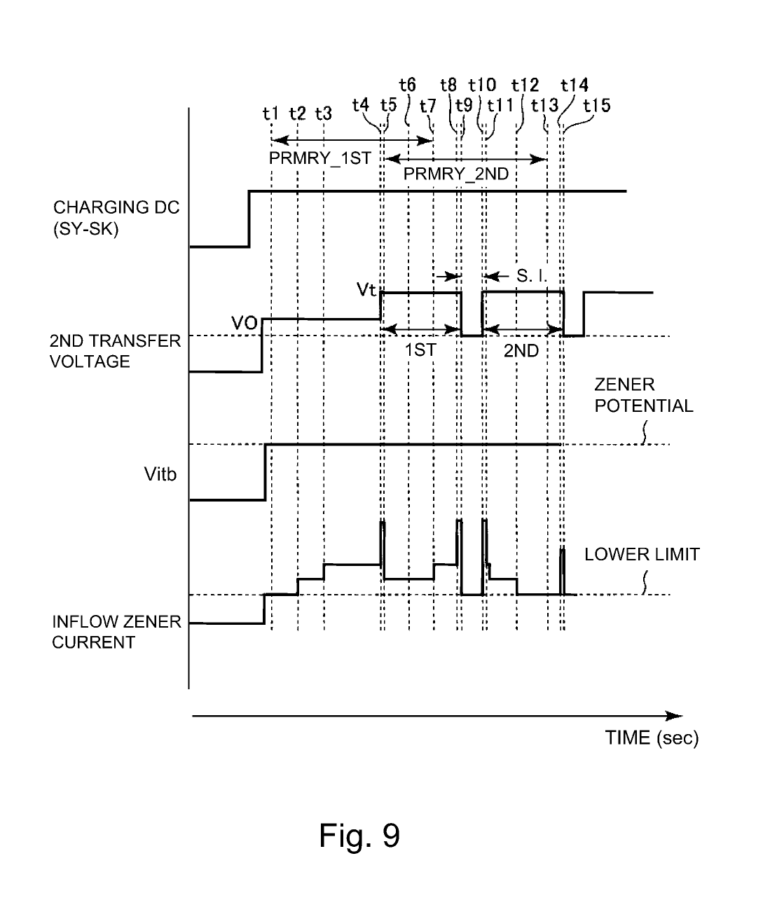

FIG. 9 is a timing chart in the case where the voltage applied from the secondary transfer voltage source 210 to the secondary transfer roller 7 between t9 and t10 is corrected in the sequence shown in FIG. 8.

As described above, in this embodiment, the current detecting means 205 for detecting the current flowing through the constant-voltage element 9 is provided. When the same image is continuously formed on a plurality of recording materials P, the controller 150 as the adjusting means makes the following adjustment on the basis of a detection result of the current detecting means 205 during the primary transfer of the toner image onto the first recording material P of the plurality of recording materials P.

That is, the controller 150 adjusts the voltage applied from the voltage source to the transfer member 7 during execution of the primary transfer of the toner image onto the second recording material P and later of the plurality of recording material P and in a period in which the secondary transfer is not executed.

As described above, according to this embodiment, in the constitution from which the voltage source exclusively for the primary transfer is omitted, in the case where the same image is continuously formed, the lower limit voltage V0 necessary to constantly maintain the potential Vitb of the intermediary transfer belt 5 at the Zener voltage is corrected depending on the detection results of the in-flow ammeter 205. As a result, the deterioration of the secondary transfer roller 7 due to energization is suppressed, so that it becomes possible to realize lifetime extension of the secondary transfer roller 7.

### OTHER EMBODIMENTS

The present invention was described based on the specific embodiments mentioned above, but is not limited to the above-mentioned embodiments.

In the above-described embodiments, the image forming apparatus of the tandem type including the plurality of image forming portions was described as an example, but the present invention is not limited thereto. Conventionally, a so-called one-drum type image forming apparatus in which not only toner images of a plurality of colors are successively formed on a single photosensitive member but also the toner images are successively primary-transferred onto the intermediary transfer member and then are collectively transferred onto the recording material has been known. The present invention is also applicable to such an image forming apparatus, and it is possible to obtain an effect similar to the effect in the above-described embodiments.

In the above-described embodiments, during the transfer step (primary transfer step, secondary transfer step), the secondary transfer voltage source applies, to the secondary transfer member, the voltage subjected to the constant-voltage control as described above, but the present invention is not limited thereto. In order to maintain the potential of the intermediary transfer member at a certain level, the voltage subjected to the constant-voltage control may also be applied so as to supply a predetermined current. In this case, as in the above-described embodiments, a set value of an output of the secondary transfer voltage source is changed so that a current value detected by the transfer ammeter is a predetermined value, whereby a voltage for supplying a predetermined current can be applied from the secondary transfer voltage source to the secondary transfer member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-020757 filed on Feb. 4, 2015, which is hereby incorporated by reference herein in its entirety.

What is claimed is:

1. An image forming apparatus comprising:
an image bearing member for bearing a toner image;
an intermediary transfer member for carrying the toner image primary-transferred from said image bearing member at a primary transfer position;
a plurality of stretching members for stretching said intermediary transfer member in contact with an inner peripheral surface of said intermediary transfer member;
a transfer member, urged from an outer peripheral surface of said intermediary transfer member toward said intermediary transfer member, for secondary-transferring the toner image from said intermediary transfer member onto a recording material at a secondary transfer position;
a constant-voltage element, electrically connected between said intermediary transfer member and a ground potential, for maintaining a predetermined voltage by a flow of a current therethrough;
a voltage source for applying a voltage to said transfer member so as to form a secondary transfer electric field at the secondary transfer position and a primary transfer electric field at the primary transfer position;
an obtaining portion for obtaining information on an image ratio of the toner image formed on said image bearing member;
a voltage controller for controlling said voltage source so that a first voltage is applied to said transfer member in a period in which primary transfer of the toner image is executed and secondary transfer of the toner image is not executed and so that a second voltage larger than the first voltage is applied to said transfer member in a period in which the secondary transfer of the toner image is executed; and
an adjusting portion for adjusting the first voltage on the basis of the information obtained by said obtaining portion.

2. An image forming apparatus according to claim 1, wherein said adjusting portion adjusts an absolute value of the first voltage at a first image ratio so as to be larger than that at a second image ratio smaller than the first image ratio.

3. An image forming apparatus according to claim 1, wherein said adjusting portion adjusts the first voltage so that said constant-voltage element maintains the predetermined voltage.

4. An image forming apparatus according to claim 1, wherein said intermediary transfer belt is an endless belt.

5. An image forming apparatus according to claim 1, wherein said constant-voltage element is a Zener diode or a varistor.

6. An image forming apparatus according to claim 1, wherein said intermediary transfer member has a multi-layer structure in which an electric resistance of a surface layer is higher than an electric resistance of another layer.
